(19) United States
(12) Patent Application Publication
(10) Pub. No.: US 2024/0090368 A1
(43) Pub. Date: Mar. 21, 2024

(54) Method for Spreading Broadcasting Material Using an Agricultural Spreader

(71) Applicant: Amazonen-Werke H. Dreyer SE & Co. KG, Hasbergen (DE)

(72) Inventors: Andre GROSSE BRINKHAUS, Münster (DE); Jörg MEYER ZU HOBERGE, Westerkappeln (DE)

(73) Assignee: Amazonen-Werke H. Dreyer SE & Co. KG, Hasbergen (DE)

(21) Appl. No.: 18/277,355

(22) PCT Filed: Feb. 9, 2022
(86) PCT No.: PCT/EP2022/053050

§ 371 Date: Aug. 15, 2023

(30) Foreign Application Priority Data
Feb. 15, 2021 (DE) 10 2021 103 451.5

(51) Int. Cl. A01C 17/00

(52) U.S. Cl. CPC A01C 17/008; A01C 17/001

(57) ABSTRACT

A method for spreading broadcasting material using an agricultural spreader is provided, and in particular with an open-loop and/or closed-loop control device in which open-loop and/or closed-loop control with at least one adjustment parameter is provided for the spreader and is configured to influence on the basis of the at least one adjustment parameter a spread pattern of the broadcasting material that can be spread by the spreader, where a need for the adaptation of a control behavior of the at least one adjustment parameter is detected, and after the detection of the need for the adaptation of the control behavior, the control behavior of the at least one adjustment parameter is adapted; where a need for adjustment parameter adaptation for influencing the spread pattern is additionally detected, and one or more adjustment parameters with adapted control behavior are changed after the need for adjustment parameter adaptation has been detected.

The disclosure relates to a method for spreading broadcasting material using an agricultural spreader and an agricultural spreader.

Agricultural spreaders are used to spread broadcasting material, in particular seed and/or fertilizer, in the form of solid and/or granular material onto arable farm land. Generic spreaders can be configured to be carried or towed. To spread the broadcasting material, adjustments must be made at the spreader so that an intended spread pattern or intended distribution of broadcasting material on the arable land can be implemented during the spreading process. A corresponding method is described, for example, in EP 3 152 993 B1. Such a spreader is provided with open-loop and/or closed-loop control by way of an associated open-loop and/or closed-loop control device, which allows the spread pattern that can be spread using the spreader to be influenced on the basis of at least one adjustable adjustment parameter.

In order to at least almost avoid losses in the spread pattern that is spread due to fluctuating operating conditions of the spreader itself and/or ambient conditions, such adjustment parameters of the spreader are always adapted to the current situation during the spreading process. Since the requirements regarding yield performance and/or environmental pollution are becoming more and more important, the adjustment parameters of modern spreaders with increasing speed and/or precision are being adapted. In particular during critical or strongly fluctuating operating conditions and/or ambient conditions, such as along uneven terrain, on slopes, at field boundaries, during starting or braking processes or with fluctuations within the broadcasting material to be spread, particularly precise and/or fast-reacting control behavior of adjustment parameters of a spreader is indispensable.

The problem with such spreaders and/or methods, however, is the at least almost instantaneous adaptations of the adjustment parameters that are associated with relatively small and/or short-term fluctuations in the ambient conditions and/or operating conditions. Such adaptations of the adjustment parameters have a negative effect on the electrical and/or mechanical loads, in particular the wear and tear of the spreader and therefore have major drawbacks in terms of energy efficiency and/or operational reliability. For example, this can result in disruptions in the electrical supply, in particular the supply voltage, and/or give rise to increased wear within the spreader.

In other sectors of agriculture, types of agricultural implements have become known which exhibit an adaptive and therefore situation-dependent control behavior. They therefore allow for the control behavior to be adapted in dependence of different operating conditions and/or ambient conditions.

For example, EP 2 286 657 B1 proposes monitoring operating parameters of individual actuators, in particular drives, within the implement in order to detect different external loads and to closed-loop control the respective actuator accordingly, in particular the drive and/or its power consumption, in dependence of the situation.

Furthermore, a method is known from DE 10 2017 106 342 A1 in which the control and therefore also the actuators of the working device, which is in particular configured as a field sprayer, are adaptively adapted in dependence of external influences or ambient conditions. For this purpose, the need for the adaptation of the control behavior is detected and subsequently adapted. It is proposed there in particular to dampen with varying control behavior the vibrations of a linkage using such a method and/or such closed-loop control.

The known agricultural implements and methods for adaptively controlling the agricultural spreading machine have the decisive drawback that actual open-loop and/or closed-loop control of the spreading process remains at least almost unaffected by the operating condition and/or the work situation of the implement and the spreading process is therefore not adapted to the different operating conditions and/or work situations. In other words, such known methods do not affect the actual spreading process at all, or at least only indirectly.

However, in a large number of fields of application, in particular when operating agricultural spreaders, the efficiency, operational reliability and/or the spreading result could be further improved if the control behavior of the spreading itself were adapted, in particular directly, in dependence of the situation. The object underlying the disclosure is therefore to further increase the possible options of use of such adaptive closed-loop controls and, in particular, to make them available for the spreading process using agricultural spreaders.

This object is satisfied by a method according to claim 1 and/or an agricultural spreader according to claim 8.

Reference is again made in this regard in particular to EP 3 152 993 B1, the content of which, preferably the manner of adapting the adjustment parameters for influencing the spread pattern, is hereby incorporated into this application.

A method according to at least one embodiment of the disclosure therefore comprises open-loop and/or closed-loop control that is provided to the spreader and is configured to influence on the basis of the at least one adjustment parameter a spread pattern of the broadcasting material that can be spread by the spreader. Furthermore, the need for the adaptation of a control behavior of the at least one adjustment parameter is detected. The control behavior of the at least one adjustment parameter is subsequently changed. If furthermore a need for adjustment parameter adaptation for influencing the spread pattern is detected, then one or more adjustment parameters with an adapted control behavior are changed after the need for adjustment parameter adaptation has been detected.

As a result of the measure according to the disclosure, a method for spreading broadcasting material is therefore created in which the control behavior of the adjustment parameters and therefore the spreading process are adapted, preferably in an automated and in an intended manner, to various operating conditions and/or ambient conditions during the spreading process. As an alternative or in addition thereto, it is also conceivable for an operator to change the control behavior manually, in particular using an associated control and/or display device, or to adapt it to the respective operating condition and/or the respective ambient conditions. In this case, necessary evaluation and/or arithmetic operations of the closed-loop control device for influencing the adjustment parameters are preferably adapted at least in part. With at least approximately the same requirement and/or the same input of broadcasting material to be spread onto the arable land, the closed-loop control device and/or the spreader is thereby enabled to adapt at least in part the spreading process based on differing operating conditions and/or ambient conditions to the respective, in particular current, situation. In particular, the reaction and/or response behavior of the spreader, in particular of the at least one adjustment parameter, is thus adapted to changes in the operating condition of the spreader, to changes in the properties of the broadcasting material and/or to the ambient conditions by changing the control behavior.

Particularly preferably, the at least one adjustment parameter is controlled in an open-loop and/or closed-loop manner with a changed or adapted control behavior until a deviation in the spread pattern and/or the spreading result, the properties of the broadcasting material, and/or the ambient conditions caused due to a changed operating condition of the spreader is corrected and/or is minimized at least almost entirely.

This embodiment allows for a particularly efficient, precise, and, at the same time, operationally reliable embodiment of the method for spreading the broadcasting material. The at least one adjustment parameter is therefore controlled in an open-loop and/or closed-loop manner with a comparatively sensitive control behavior only in the situations or regions required for this.

The requirements and/or the need for broadcasting material to be spread is there preferably entered manually by an operator, in particular using a control and/or display device, and/or retrieved in an automated manner, in particular in a manner that is specific for a partial area and/or by the open-loop and/or closed-loop control device.

Furthermore, the agricultural spreader preferably comprises at least one monitoring device which is configured to detect the broadcasting material and/or a lateral distribution of the broadcasting material. The broadcasting material and/or the lateral distribution of the broadcasting material can preferably be detected without contact and/or immediately after and/or when exiting from the spreader using the at least one monitoring device. The monitoring device is furthermore configured preferably in the manner of a radar sensor. The spreader particularly preferably comprises a plurality of monitoring devices which detect the broadcasting material during the spreading process, in particular directly behind the spreader.

In a preferred embodiment of the method according to the disclosure, the spreader, in particular the open-loop and/or closed-loop control device, is configured to control in an open-loop and/or closed-loop manner the at least one adjustment parameter in dependence of the lateral distribution detected. If a, in particular current, lateral distribution detected by way of the at least one monitoring device is outside of an acceptance range that can be predefined for the respective operating condition and/or for the respective ambient condition, then the at least one adjustment parameter is adapted, in particular, by a changed control behavior. The adaptation is effected in such a way that the detected and/or current lateral distribution is changed at least in part in the direction of a target lateral distribution that can be predefined and/or retrieved. With such an embodiment, the interaction between the adapted control behavior and the lateral distribution and therefore for the spreading result can be adapted particularly well and in a simple manner.

The spreader preferably comprises at least one adjustable feed device and at least one spreading disk that is drivable in a rotating manner, where the feed device is configured to feed the broadcasting material from a storage container of the spreader in required quantities and at an adjustable feed point onto the spreading disk. Furthermore, the feed device preferably has at least one metering opening that is associated with the at least one spreading disk and/or is adjustable relative to the spreading disk, where the feed point is adaptable by adjusting the metering opening. Preferably, the feed device has at least one metering element associated with the spreading disk which is configured to meter a quantity of broadcasting material that can be advanced in the direction of the spreading disk, in particular the feed point, and then be spread onto the arable land. The spreader is configured in particular in the manner of a centrifugal fertilizer spreader, where the broadcasting material delivered onto the at least one rotating spreading disk, that preferably has an adjustable rotational speed, is cast in the direction of the arable land. The monitoring device is there particularly preferably associated with the at least one spreading disk and/or is aligned with a fan of broadcasting material that forms in the direction of travel behind the spreader. The at least one monitoring device is furthermore preferably configured to detect the flight characteristics, in particular flight direction and/or flight velocity, of the broadcasting material, in particular of individual grains. This embodiment has the advantage that the control behavior of the actuators, components or parts directly associated with the distribution and/or the spread pattern is adapted. They typically exhibit the greatest frequency of adaptation during the distribution.

In a further development of the method according to the disclosure, the spreader, in particular the open-loop and/or closed-loop control device, is configured to control on the basis of the at least one adjustment parameter in an open-loop and/or closed-loop manner the feed device and/or the spreading disk, in particular the metered quantity and/or the feed point of the broadcasting material. In particular, the transverse distribution and/or flight characteristics, in particular flight velocity and/or flight direction, of the broadcasting material are adapted in this way. Interventions of this kind at the feed device and/or spreading disk influence in particular the casting speed and/or casting direction, in particular the casting angle, of the broadcasting material, resulting directly from the spreading disk. Accordingly, the at least one adjustment parameter preferably represents a position of the metering opening and therefore of the feed point onto the spreading disk, a metering quantity of the broadcasting material, and/or a rotational speed of the spreading disk.

In another preferred embodiment of the method according to the disclosure, changing the control behavior causes a change in a control velocity of the at least one adjustment parameter. When changing the control behavior, the control velocity of the at least one adjustment parameter is preferably increased or decreased. Depending on the situation, a response and/or reaction velocity of the spreader, in particular of the feed device, is thereby adapted to the fluctuations in the ambient conditions, of the properties of the broadcasting material and/or of the operating conditions. An adaptation of the control velocity is necessary in particular if the spread pattern to be obtained and/or the desired lateral distribution cannot be obtained or implemented sufficiently quickly with an already adjusted or current control velocity. If the spreader is in a critical operating condition and/or a critical ambient condition, then the control velocity can be increased by many times with relatively small fluctuations, preferably by about 5-10 times, over a non-critical operating condition and/or a non-critical ambient condition. The responsiveness of the spreader, in particular of the feed device, is therefore comparatively high during critical operating conditions and/or ambient conditions.

The spreading process outside of critical operating conditions and/or ambient conditions is therefore adapted in such a way that, on the one hand, a spread pattern that is still satisfactory is obtained and, on the other hand, the spreader, in particular the feed device, reacts less sensitively or with increased inertia to fluctuations and is therefore relieved at least in part. When using such an embodiment, at least an almost best possible compromise between particularly high spreading accuracy and a high level of efficiency and/or operational reliability can be obtained.

In the following, the operating conditions and/or ambient conditions or changes therein are to be understood to mean any variable and/or effect influencing the spreader, the broadcasting material, and/or the spread pattern. Due to changes in the operating status and/or in ambient conditions, adaptations to the previously set adjustment parameters may be necessary in order to be able to obtain the intended and/or necessary spread pattern. The operating conditions include, for example, an altitude, inclination, acceleration, speed and/or a steering behavior of the spreader. The ambient conditions mean influences such as air temperature, humidity, air movements such as wind speed and/or wind direction. In addition, this can also be understood to mean the properties or the changes in the broadcasting material to be spread and/or in the arable farm land. A change in at least one of the above-mentioned influences also results in a change in the operating condition and/or in the ambient conditions.

In another development of the method according to the disclosure, the need for the adaptation of the control behavior of the adjustment parameter is detected due to at least one change in the operating condition and/or the ambient conditions that is detected, preferably by sensors, in particular when the operating condition and/or the ambient condition exceeds a predefinable acceptance range. The acceptance range is preferably predefined at the factory and/or alternatively by an operator prior to and/or during a spreading process. In this case, the acceptance range represents a still permissible change in the operating condition and/or in at least one ambient condition in which the control behavior is not changed. If an operating condition and/or an ambient condition exceeds or undercuts the acceptance range, then the control behavior is adapted to a respective necessary control behavior for obtaining an intended spread pattern. The respective, in particular adaptable, acceptance range of an operating condition and/or an ambient condition is preferably retrieved and/or set for a respective spreading process. The detection of the change in an operating condition and/or an ambient condition is detected by the spreader particularly preferably in an automated manner, in particular by the associated open-loop and/or closed-loop control device. Alternatively or additionally, it is also conceivable that the change in the operating condition and/or the ambient conditions and thereby the adaptation of the control behavior is initiated and/or carried out manually by an operator. As a result of such an embodiment, the control behavior and therefore the spreading process is smoothed and/or formed to be calm in a particularly simple manner. Short-term changes and/or outliers in particular are thereby filtered out at least almost entirely.

The spreader preferably comprises at least one sensor device which is associated therewith and/or arranged thereon and is configured to detect an operating condition of the spreader and/or an ambient condition or changes therein. Such a sensor device can be configured, for example, as an inclination, distance, acceleration, temperature, humidity and/or flow sensor. In addition, sensor devices which are configured to detect the properties and/or the condition of the broadcasting material and/or the filling level of at least one storage container arranged at the spreader are also conceivable. Alternatively or additionally, it is also conceivable that the change in the operating condition and/or the ambient condition is detected and/or predefined manually by an operator.

In a further preferred embodiment of the method according to the disclosure, refilling and/or changing the broadcasting material causes a change in the operating condition, in particular within a storage container of the spreader. In particular, a change in the operating condition takes place when a previously filled broadcasting material has been at least almost consumed during the spreading process and the storage container is filled with new broadcasting material. A change in the broadcasting material during the spreading process, in particular with changed casting, flight and/or impact properties, is preferably also detected as a change in the operating condition.

Furthermore, as an alternative or in addition, a change or a changeover in the direction of travel, the travel lane and/or the inclination of the spreader causes a change in the operating condition. Changes or a change-over in the direction of travel and/or travel lane or a travel track can result, for example, from larger steering motions of the spreader, while the control behavior is preferably maintained in the case of comparatively small evasive maneuvers by the spreader. Inclinations or changes in inclination of the spreader are particularly preferably detected using at least one sensor device arranged at the spreader when driving over unevenness or a slope along the arable land. For example, if the inclination, in particular a yaw, pitch, and/or roll rate, of the spreader exceeds a predefined inclination limit, in particular a limit value, a change in the operating condition is detected and the control behavior, in particular the control velocity, of the spreading process is adapted accordingly. Alternatively or additionally, differences in altitude and/or expected inclinations of the spreader at specific positions along the arable land can be retrievable by the open-loop and/or closed-loop control device. A change in the operating condition is preferably also caused by a change in the travel speed of the spreader. This can be caused in particular by the acceleration and/or deceleration of the spreader. A change in the operating condition is preferably also caused by exceeding or not maintaining a critical distance from a field boundary. Such an embodiment allows for particularly quick adjustment and thereby adaptation of the spreader, in particular of the feed device, to fluctuating operating conditions.

In a further preferred embodiment, changes in the air movement cause, in particular directly, a change in the ambient conditions at the spreader and thereby in the control behavior of the spreader, in particular of the feed device. Such air movements there represent a wind direction and/or wind speed, which can be retrieved in particular by the spreader and/or can be detected using at least one sensor device. Furthermore, changes in the air temperature and/or air humidity are preferably also considered to be ambient conditions to be taken into account.

In a further development of the method according to the disclosure, the control behavior, in particular the control velocity, of the at least one adjustment parameter is reset for at least one operating condition of the spreader and/or an ambient condition once a predefinable time has elapsed and/or once a predefinable acceptance range has been reached. In this case, the change in the control behavior, in particular the control velocity, is preferably carried out temporarily during the spreading process. For example, a rather sensitive control behavior, in particular at a higher control velocity, within a critical operating condition and/or a critical ambient condition can then be reduced, in particular to an initial state. Alternatively or additionally, a predefinable time can be defined, for example at the factory or individually by an operator, within which the control behavior, in particular the control velocity, is changed. Such an embodiment allows for significantly simplified handling of the method according to the disclosure for an operator. Operating errors in particular are then ruled out at least almost entirely.

At least one object underlying the disclosure is also satisfied by an agricultural spreader, in particular a fertilizer spreader, having at least one open-loop and/or closed-loop control device, where the agricultural spreader, in particular the open-loop and/or closed-loop control device, is configured to carry out a method according to at least one of the above embodiments. With regard to the advantages and modifications of the spreader according to the disclosure, in particular the fertilizer spreader, reference is first made to the advantages and modifications of the method according to the disclosure.

Further details of the disclosure can be gathered from the description of the examples and the drawings, where the drawing in

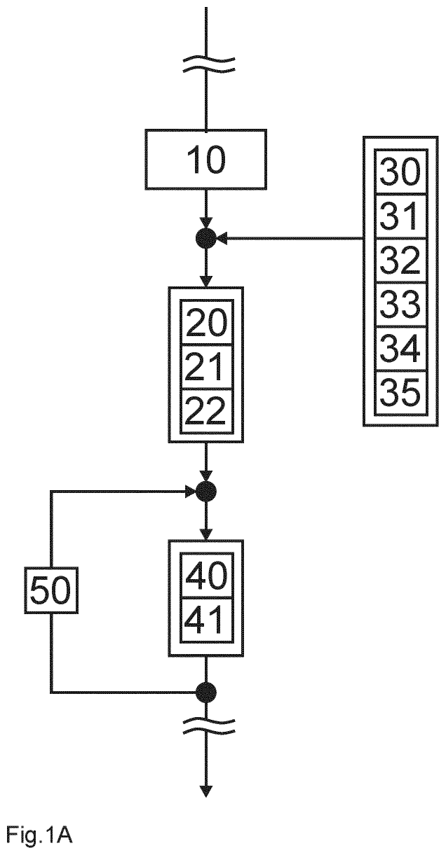

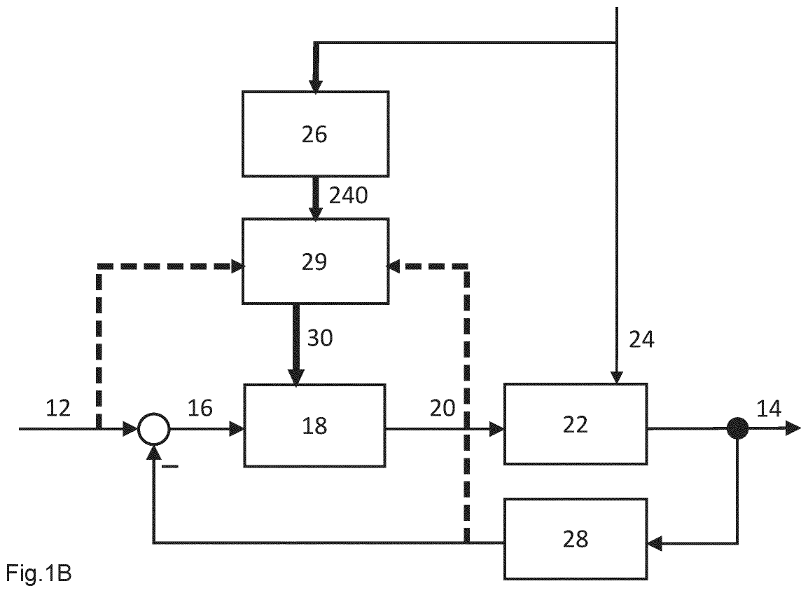

FIG. 1A shows a schematic representation of a method according to at least one embodiment of the disclosure for closed-loop control of an agricultural spreader;

FIG. 1B shows a schematic representation of closed-loop control of the method according to at least one embodiment of the disclosure and/or of the spreader; and

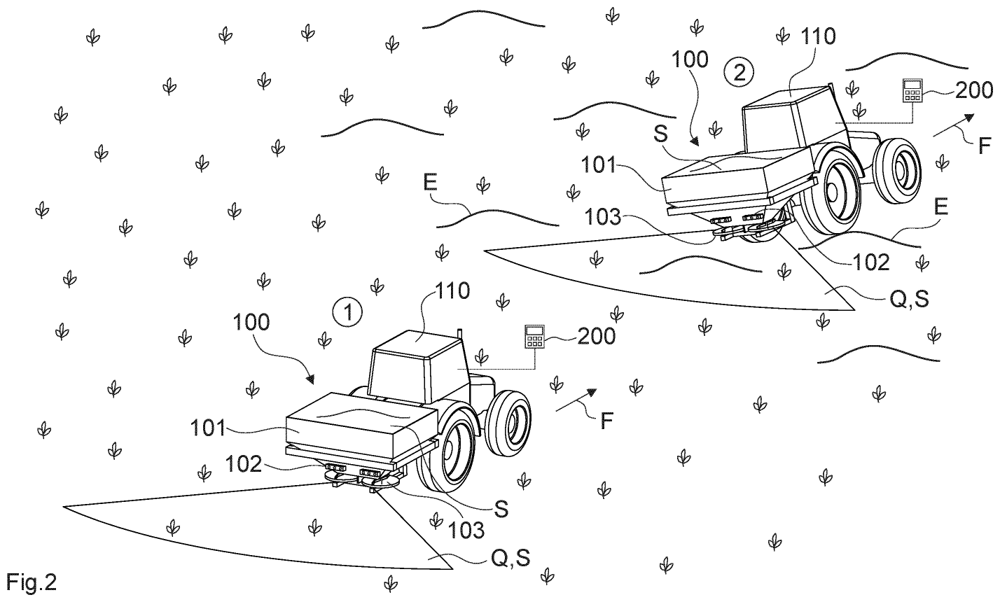

FIG. 2 shows a spreader according to at least one embodiment of the disclosure in different operating conditions during the spreading process in a perspective view from behind.

A method for spreading broadcasting material S, in particular fertilizer, onto arable farm land using an agricultural spreader 100 is shown in FIG. 1A. The method is shown there as a schematic flowchart and is initiated by the following step:
10) providing open-loop and/or closed-loop control for spreader 100 with at least one adjustment parameter.

An open-loop and/or closed-loop control device 200 associated with spreader 100 there provides open-loop and/or closed-loop control that is configured to influence on the basis of the at least one adjustment parameter a spread pattern that can be spread using spreader 100 and thereby the spreading process of broadcasting material S.

In order to always obtain an intended and/or needs-based spread pattern on the arable land during the spreading process and to at least almost avoid or minimize losses in the spreading yield, the at least one adjustment parameter is continuously adapted during the spreading process with a control behavior 30 adjusted by the open-loop and/or closed-loop control device, in particular by open-loop and/or closed-loop control.

During the spreading process, however, it can be expedient for improving the spreading result and/or to increase the efficiency and/or the operational reliability of spreader 100 to perform the adaptation of the at least one adjustment parameter with a control behavior 30 that is dependent upon the operating condition and/or the ambient conditions.

Therefore, the following steps are performed during the spreading process:
20) detecting the need for the adaptation of a control behavior 30 of the at least one adjustment parameter; and
21) changing control behavior 30 of the at least one adjustment parameter after the need for the adaptation of control behavior 30 has been detected.

Step 21) can there also be supplemented or replaced by the following step:
22) changing a control velocity of the at least one adjustment parameter.

The need for the adaptation of control behavior 30 is therefore detected when an operating condition of spreader 100, a property of the broadcasting material, and/or an ambient condition, in particular directly at and/or around spreader 100, changes at least in part. In particular, the need for the adaptation of control behavior 30 of the at least one adjustment parameter is detected where a predefined acceptance range of the, in particular current, operating condition 1, 2, the property of the broadcasting material, and/or the ambient condition is exceeded or has been undercut, respectively.

In particular, the need for the adaptation of control behavior 30 is triggered by at least one of the following steps and/or conditions:
30) a refill and/or a change in broadcasting material S, in particular within a storage container 101 of spreader 100; and/or
31) a correction of or a change in a direction of travel F and/or travel lane of spreader 100; and/or
32) exceeding or not maintaining a critical distance from a field boundary; and/or
33) a change in an inclination and/or orientation of spreader 100; and/or
34) a change in speed of travel of spreader 100; and/or
35) a change in air movement, air temperature and/or humidity, in particular directly, at spreader 100.

Once control behavior 30, in particular the control velocity, of the at least one adjustment parameter and thereby of the response and/or reaction behavior of spreader 100 has changed, the following steps are carried out during the spreading process:
40) detecting the need for an adjustment parameter adaptation for influencing the spread pattern; and
41) changing one or more adjustment parameters with adapted control behavior 30 after the need for an adjustment parameter adaptation has been detected.

The open-loop and/or closed-loop control device, in particular the open-loop and/or closed-loop control provided therewith, is configured to adapt the at least one adjustment parameter with a control behavior 30, in particular a control velocity, that is dependent upon the operating condition of spreader 100, the properties of the broadcasting material, and/or the ambient conditions.

For example, it can be expedient there to classify respective operating conditions 1, 2, properties of the broadcasting material, and/or ambient conditions into critical or non-critical spreading situations. Such critical spreading situations can be, for example, spreading with comparatively large steering maneuvers, in particular changing travel lanes or travel tracks, of spreader 100, spreading broadcasting material S in the vicinity of field boundaries, large inclines of spreader 100, in particular when travelling on a slope, or significant changes in driving speed for the spreading process. In addition, a change in broadcasting material S, in particular when broadcasting material S has differing properties at least in part which influence the spreading result. Furthermore, air movements that are comparatively strong and/or that have changed over a longer period of time, in particular a changed wind speed and/or wind direction, can also be classified as being critical. Accordingly, particularly short-term changes in operating conditions 1, 2 and/or ambient conditions, in particular in the form of outliers, are classified as being uncritical, in particular where no need for the adaptation of control behavior 30 of the at least one adjustment parameter in general is not given. On the other hand, spreading situations, for example, spreading within the field on comparatively level terrain, in particular with only little or no unevenness E, in which spreader 100 is moved at least almost continuously horizontally, are considered to be non-critical.

The method is also alternatively or additionally supplemented by the following step:
50) resetting control behavior 30, in particular the control velocity, of the at least one adjustment parameter for at least one operating condition 1, 2 of spreader 100 and/or an ambient condition once a predefinable time has elapsed and/or once a predefinable acceptance range has been reached.

Control behavior 30 of the at least one adjustment parameter, which has been adapted to the critical spreading situations, is there at least almost adapted to the non-critical spreading situation, in particular is reset. This is carried out once the operating condition of spreader 100, the properties of the broadcasting material and/or the ambient conditions reach the predefined acceptance range, in particular a permissible limit value. Alternatively or additionally, control behavior 30 of the at least one adjustment parameter is reset to original control behavior 30 after a predefined time has elapsed. In addition, control behavior 30 can be reset alternatively or additionally when an, in particular detectable, deviation in the spread pattern in the properties of the broadcasting material and/or in the ambient conditions caused by a change in operating condition 1, 2 are at least almost completely corrected and/or minimized

Corresponding closed-loop control of the method according to the disclosure and/or of spreader 100 is shown in an alternative and/or additional illustration in FIG. 1B. A reference variable 12 is compared with a control variable 14 to detect and/or determine a control deviation 16.

Control deviation 16 is fed to a controller 18, where controller 18 outputs an actuating variable 20 on the basis of an adjustable control behavior 30 and the adjustment parameters, which is transferred to a controlled system 22. Controlled system 22 there represents, for example, a feed device and/or spreading disk 103 of agricultural spreader 100, the behavior of which is to be controlled using closed-loop control.

Closed-loop control 10 comprises a monitoring device 28 which is configured to detect control variable 14. According to this exemplary embodiment, monitoring device 28 is configured as a radar sensor, in particular for detecting broadcasting material S and/or lateral distribution Q. As an alternative or in addition thereto, monitoring device 28 can also be configured, for example, as a rotational speed sensor, in particular for detecting a rotational speed at least of spreading disk 103. The monitoring device detects control variable 14 and then also takes into account one or more disturbance variables 24.

Control behavior 30 can there be influenced and/or adapted using a control adjustment member 29. Control adjustment member 29 there takes into account a disturbance variable signal 240 which is detected by sensor device 26 on the basis of disturbance variable 24. Sensor device 26 is there configured to detect at least one operating condition and/or one ambient condition, in particular changes therein. For example, sensor device 26 can be configured as an inclination sensor, wind sensor, or as a sensor similar thereto.

Alternatively or additionally, control adjustment member 29 takes reference variable 12 and/or control variable 14 into account.

The need for an adaptation of control behavior 30, in particular due to a critical operating condition of spreader 100 and/or a critical ambient condition, is detected on the basis of the variables taken into account by control adjustment member 29.

FIG. 2 shows an agricultural implement carried by a towing vehicle 110 and configured as a spreader 100, in particular as a centrifugal fertilizer spreader, during the spreading process of broadcasting material S. Broadcasting material S, which is stored within a storage container 101 of spreader 100, is spread onto the arable farm land by way of two rotating spreading or centrifugal disks 103 arranged below storage container 101.

In addition to the spreading disks 103, which form the spreading mechanism at least in part, spreader 100 has a feed device (not shown in the figure) for feeding broadcasting material S onto spreading disks 103 as required. The feed device comprises a metering opening respectively associated with spreading disks 103 and a metering element for metering the quantity of broadcasting material S to be spread. The metering openings are there adjustable concentrically with respect to spreading disks 103 and are part of a feed point adjustment that is already known from prior art. The feed point there represents a transfer position of the broadcasting material S from storage container 101 onto the respective centrifugal disk.

Broadcasting material S is detected there, in particular after and/or when exiting from spreader 100 and/or when being cast off spreading disks 103, by way of several monitoring devices 102 arranged at spreader 100. Monitoring devices 102 are there formed as non-contact sensors, in particular radar sensors, and are configured to detect a transverse distribution Q of broadcasting material S within a fan of broadcasting material forming behind spreader 100. In particular, the casting direction and/or a flight speed of broadcasting material S within the fan of broadcasting material are detected by monitoring device 102. Open-loop and/or closed-loop control of the spreading process, in particular of the feed device and/or spreading disk 103, also takes place in dependence of broadcasting material S and/or lateral distribution Q detected by monitoring devices 102.

The at least one adjustment parameter in this embodiment therefore represents a position of the metering opening and therefore of the feed point on spreading disk 103, a metering quantity of broadcasting material S, and/or a rotational speed of spreading disk 103.

Two different operating conditions 1, 2 and/or discharge situations of spreader 100 are furthermore to be seen in FIG. 2. The first position of spreader 100 represents a non-critical spreading situation with a relatively small or at least almost no inclination of spreader 100 relative to the arable land located in direction of travel F behind spreader 100. Control behavior 30, in particular the control velocity, is comparatively sluggish and/or set to be less sensitive. The second position of spreader 100, which presently represents a critical spreading situation, shows spreader 100 when driving over uneven terrain, where spreader 100 has a relatively large incline in relation to the surface located in direction of travel F behind spreader 100. The incline of spreader 100 there exceeds a critical limit value which is likewise detected by a sensor device, in particular an inclination sensor, associated with spreader 100. A change in operating condition 1, 2 of spreader 100 is detected therewith and control behavior 30, in particular the control velocity, of the at least one adjustment parameter is adapted. In particular, control behavior 30 of the at least one adjustment parameter in the second or critical spreading situation, respectively, has a control velocity that is approximately 5-10 times faster than in the first or non-critical spreading situation. As an alternative thereto, other control velocities are also conceivable in which the control velocity can be, for example, up to about 100 times that of the control velocity in the non-critical spreading situation.

It goes without saying that the features mentioned in the embodiments described above are not restricted to these special combinations and are also possible in any other combination. Furthermore, it goes without saying that the geometries shown FIG. 2 are only by way of example and are also possible in any other configuration. Furthermore, it goes without saying that other types of different operating conditions, which are described in particular in the description, are also possible in addition to operating conditions 1, 2 shown in FIG. 2, each showing different inclinations of spreader 100.

### LIST OF REFERENCE CHARACTERS

1 first and/or non-critical work situation and/or operating condition
2 second work situation and/or operating condition
12 reference variable
14 control variable
16 control deviation
18 controller
20 actuating variable
22 controlled system
24 disturbance variable
26 sensor device
240 disturbance variable signal
28 measuring device
29 control adjustment member
30 control behavior
100 spreader
101 storage container
102 monitoring device
103 spreading disk
110 towing vehicle
200 open-loop and/or closed-loop control device
E unevenness
F direction of travel
Q lateral distribution
S broadcasting material

1. A method for spreading broadcasting material using an agricultural spreader comprising:
providing open-loop and/or closed-loop control with at least one adjustment parameter for the spreader, where said open-loop and/or closed-loop control is configured to influence, on the basis of said at least one adjustment parameter, a spread pattern of said broadcasting material that can be spread by said spreader;
detecting the need for the adaptation of a control behavior of said at least one adjustment parameter;
changing a control behavior of said at least one adjustment parameter after the need for the adaptation of said control behavior has been detected;
detecting a need for an adjustment parameter adaptation for influencing the spread pattern; and
changing one or more adjustment parameters with adapted control behavior after the need for an adjustment parameter adaptation has been detected.

2. The method according to claim 1, where said agricultural spreader comprises at least one monitoring device which is configured to detect a transverse distribution of said broadcasting material, characterized in that said spreader, in particular said open-loop and/or closed-loop control device, is configured to control in an open-loop and/or closed-loop manner said at least one adjustment parameter in dependence of the lateral distribution detected.

3. The method according to claim 1, where said spreader comprises at least one adjustable feed device and at least one spreading disk that is drivable in a rotating manner, where said feed device is configured to feed said broadcasting material from a storage container of said spreader in required quantities and at an adjustable feed point onto said spreading disk, characterized in that said open-loop and/or closed-loop control device is configured to control on the basis of said at least one adjustment parameter in an open-loop and/or closed-loop manner said feed device and/or said spreading disk.

4. The method according to claim 1, characterized in that changing said control behavior causes a change in a control velocity of said at least one adjustment parameter.

5. The method according to claim 1, characterized in that the need for the adaptation of said control behavior of said adjustment parameter is detected due to at least one change in said operating condition and/or said ambient conditions that is detected.

6. The method according to claim 5, characterized in that at least one of the following steps causes a change in said operating condition of said spreader and/or of said ambient conditions:
a refill and/or a change in said broadcasting material, in particular within a storage container of said spreader;
a correction of or a change in a direction of travel and/or travel lane of said spreader;
exceeding or not maintaining a critical distance from a field boundary;
a change in an inclination and/or orientation of said spreader;
a change in speed of travel of said spreader; and
a change in air movement, air temperature and/or humidity, in particular directly, at said spreader.

7. The method according to claim 1, further comprising:
resetting said control behavior, in particular a control velocity, of said at least one adjustment parameter for at least one operating condition of said spreader and/or an ambient condition once a predefinable time has elapsed and/or once a predefinable acceptance range has been reached.

8. An agricultural spreader with at least one open-loop and/or closed-loop control device for spreading broadcasting material onto arable farm land, characterized in that said open-loop and/or closed-loop control device is configured to carry out the method according to claim 1.

9. The method according to claim 3, wherein characterized in that said open-loop and/or closed-loop control device is configured to control on the basis of the quantity and/or the feed point of said broadcasting material.

10. The method according to claim 5, wherein the least one change in said operating condition and/or said ambient conditions is detected by sensors.

11. The method according to claim 5, characterized in that the at least one change in said operating condition and/or said ambient conditions is said operating condition and/or said environmental condition exceeding a predefinable acceptance range.

12. The method according to claim 6, wherein the refill and/or a change in said broadcasting material is within a storage container of said spreader.
